(19) United States
(12) Patent Application Publication
(10) Pub. No.: US 2017/0114512 A1
(43) Pub. Date: Apr. 27, 2017

(54) Road Salt Drop Spreader

(71) Applicant: Christopher A. Broege, Oconomowoc, WI (US)

(72) Inventor: Christopher A. Broege, Oconomowoc, WI (US)

(21) Appl. No.: 14/922,452

(22) Filed: Oct. 26, 2015

(51) Int. Cl. E01H 10/00; B65G 11/20; B65G 11/02; B05B 15/00; B05B 13/00

(52) U.S. Cl. CPC E01H 10/007; B05B 15/003; B05B 13/005; B65G 11/026; B65G 11/206; B65G 2201/042

(57) ABSTRACT

Apparatus and associated systems relate to a vehicle-mounted drop spreader for efficiently dispensing particulate material, such as road salt, within an area having pedestrian or vehicular traffic. In an illustrative example, the drop spreader, includes a hopper filled with road salt that may be easily and quickly secured to the back of a an all-terrain vehicle (ATV) or construction vehicle. The drop spreader includes an agitator driven by a variable speed motor to direct the road salt from the hopper to the ground through holes in a sidewall of the hopper. In various implementations, a baffle is provided at the base of the hopper which eliminates the need for an auger to move salt within the hopper and for gates to stop the delivery of road salt.

### TECHNICAL FIELD

Various embodiments relate generally to aggregate material spreaders and more particularly, to vehicle-mounted drop spreaders for distributing particulate materials such as road salt, sand, or de-icing compounds to surfaces intended for vehicular or pedestrian traffic such as sidewalks, roadways, driveways, and parking lots.

### BACKGROUND

The dangers associated with icy or otherwise slippery surfaces such as roadways and sidewalks are well known. In many communities road salt is the material of choice to melt snow and ice and to help keep additional ice from forming on streets and sidewalks. The benefits of road salt include that facts that it is effective, quick acting, and typically costs less than the alternatives. The cost of road salt, however, is a variable that changes from season to season and may even fluctuate wildly within a single season. Further, the amount of road salt needed each winter can be reasonably estimated but cold seasons that are much warmer or colder than expected leave either a surplus or demand and the expensive problems associated with each. Still further, excess road salt applied to roads and sidewalks may run off into the environment, producing a negative effect to nearby grass lawns and in waterways.

For these, and other reasons, system, methods, and devices have been developed over the years attempting to reduce the amount of road salt needed to melt ice on roads and sidewalks. Improvements to the equipment that spreads and disperses the road salt have been made. For example, one vehicle-mounted road salt spreader provides better adhesion of the salt to the road (and thus requiring less overall salt) by mixing the salt with water and applying the mixture in a slurry form. Other improvements include road salt distribution systems and equipment that provide precise control over the amount and placement of road salt. Improvements to road salt spreading equipment include interchangeability between maintenance vehicles such as dump trucks, pickup trucks and ATVs, eliminating the need for expensive, stand-alone equipment.

Existing vehicle-mounted road salt spreading equipment typically includes a large hopper to hold the salt, a vertically mounted auger to move the salt within the hopper, and a delivery mechanism such as a gate and a paddle wheel to distribute the salt to the surface below. Drop spreaders offer better control and placement of road salt over spray spreaders but the weight of a full hopper of salt requires a very large electric motor or hydraulic actuator to drive the auger and move the salt to the delivery mechanism. The weight in the hopper often causes the salt in the bottom of the hopper to be crushed, decreasing its effectiveness and places a strain on the auger. Further, many existing drop spreaders use shaker motors to help keep road salt moving out of the hopper. Still further, most drop spreaders use a mechanical gate or hatch to keep the salt within the hopper when the agitator is not running. The gates may get stuck in an open, closed, or in-between position, any of which further complicates the distribution of road salt. Drop spreaders without mechanical gates have been developed but still use an auger to move the salt to the delivery mechanism and a shaker system to help keep the salt flowing.

Therefore, a need exists for a vehicle-mounted drop spreader that accurately controls the amount and placement of road salt with minimal moving parts.

### SUMMARY

In accordance with the present disclosure, an exemplary embodiment of a road salt drop spreader for dispensing road salt, or other aggregate material, onto a surface is disclosed. The drop spreader includes a mounting assembly for attaching the drop spreader to a vehicle, a hopper for holding an amount of road salt, a dispensing arrangement in communication with the hopper, and a baffle between the hopper and the dispensing arrangement configured to support the weight of the road salt within the hopper. The salt spreader further includes a removable lid to fill the hopper and a series of openings in the baffle to control the flow of road salt into the dispensing arrangement. The dispensing arrangement includes an agitator with a shaft and paddles and a series of dispensing apertures to distribute the road salt to the ground when the agitator is actuated.

The drop spreader may include an electric gear reduction motor and a variable speed controller to adjust the speed of the agitator. The baffle may be removable from the spreader.

The details of an exemplary embodiment are set forth in the accompanying drawings and the description below. Other features and advantages will be apparent from the description and drawings, and from the claims.

### BRIEF DESCRIPTION OF THE DRAWINGS

FIG. 1 depicts a perspective view of an exemplary embodiment of a road salt drop spreader with removable components including a rear access panel, lid, and baffle shown separate from the spreader;

FIG. 2 depicts a rear plan view of the road salt drop spreader of FIG. 1 with the access panel, lid and baffle removed;

FIG. 3 depicts a top plan view of the baffle of FIG. 1;

FIG. 4 depicts a front plan view of the road salt drop spreader of FIG. 1; and

FIG. 5 depicts side plan view of the road salt drop spreader of FIG. 1.

Like reference symbols in the various drawings indicate like elements.

### DETAILED DESCRIPTION OF ILLUSTRATIVE EMBODIMENTS

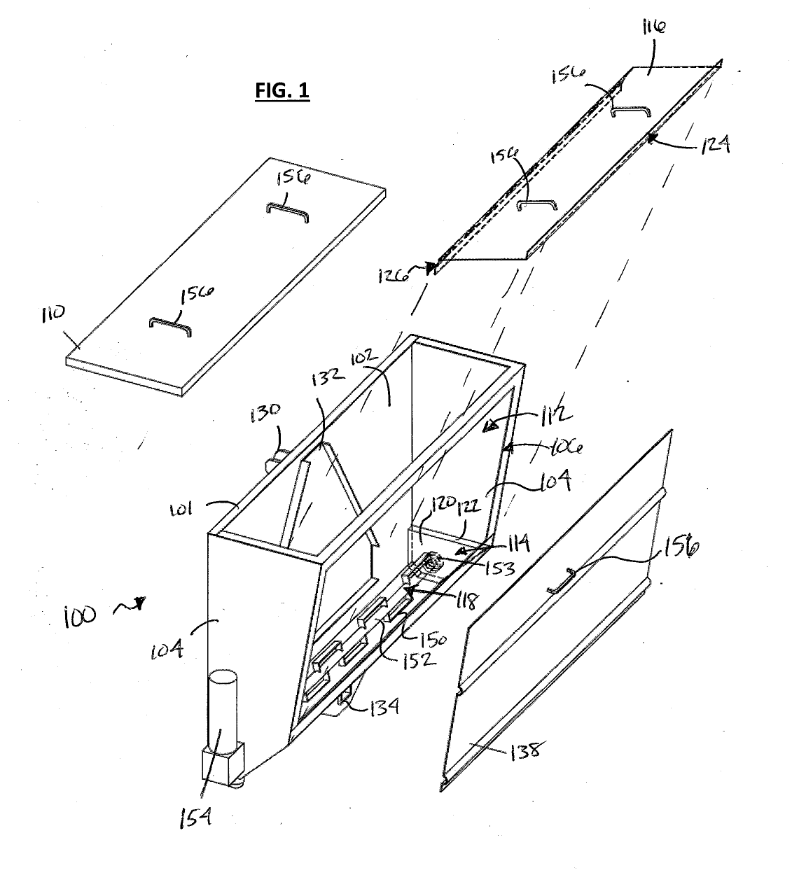

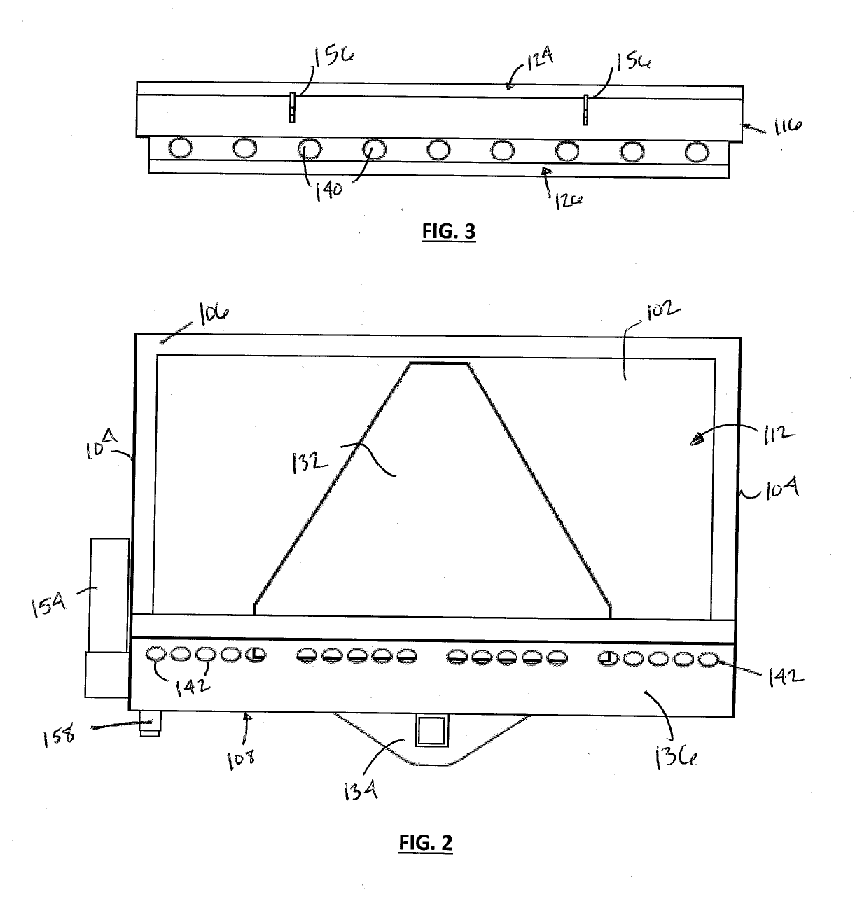

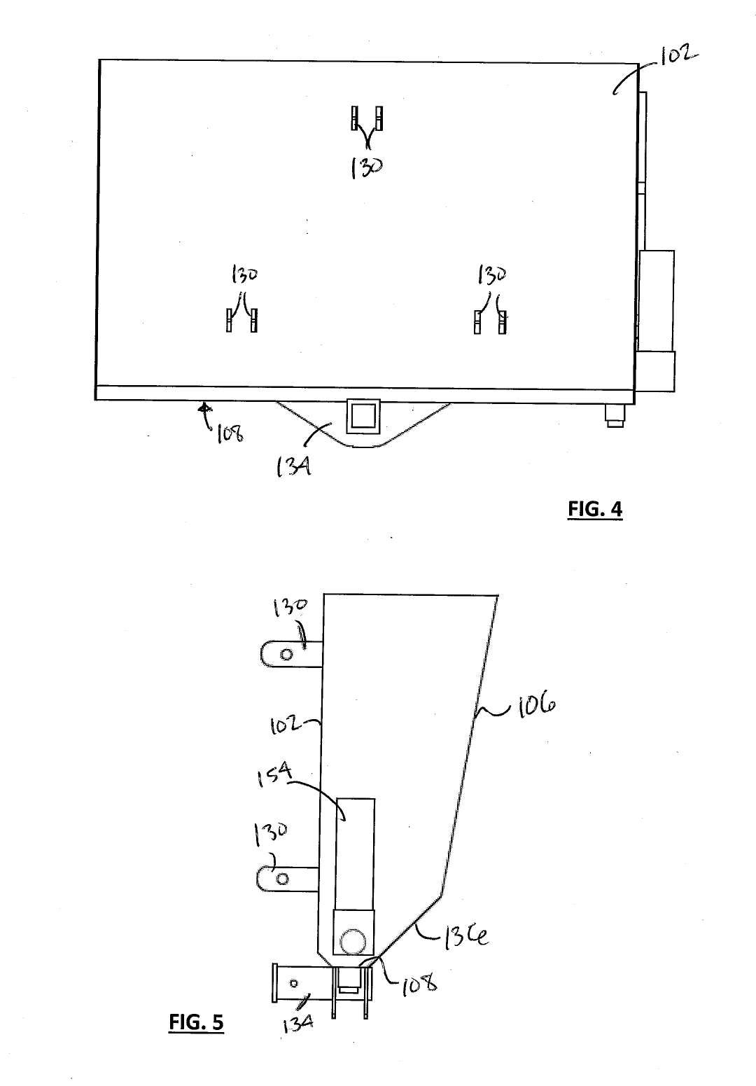

FIGS. 1-5 depict an exemplary embodiment of a road salt drop spreader 100 in accordance with the present invention. The salt spreader 100 is defined by a frame 101 supporting a front wall 102, two side walls 104, rear wall 106, base 108, and a lid 110 covering the spreader 100. The rear wall 106 extends inwardly in one or more angled planes while the front wall 102 and side walls 104 extend in a vertical plane. The preferable material of construction for the spreader 100 is stainless steel but other non-corrosive materials such as plastic may be utilized.

The interior of the spreader 100 includes a hopper 112 and a dispensing arrangement 114 separated by a generally flat removable baffle 116. The dispensing arrangement 114 includes an agitator 118 positioned beneath the hopper 112 and supported at each end by a mount 120 fixedly secured to the side walls 104 adjacent to the base 108. When placed inside of the spreader, the baffle 116 is supported by a flat upper surface 122 of each agitator mount 120 to form a bottom wall of the hopper 112. The baffle 116 includes an upwardly angled lip 124 and a downward sloping portion 126 both extending along the entire length of the baffle 116 and hopper 112. The lip 124 abuts, and is supported against, the angled rear wall 106 while the downward sloping portion 126 extends to the front wall 102 to physically separate the hopper 112 from the dispensing arrangement 114.

Six mounting tabs 130 and a triangular support 132 are welded, or otherwise securely affixed, to the front wall 102 to form a three-point hitch arrangement as is known in the art. The arrangement of the mounting tabs 130 enables the spreader 100 to be removably mounted to a large tractor or other similar implement. Alternatively, the spreader 100 may be attached to a smaller vehicle such as a lawn tractor, ATV, or pickup truck with an SAE Class III-rated receiver hitch assembly 134 secured to the base 108.

The rear wall 106 includes a lower fixed portion 136 and a removable access cover 138. A single piece of stainless steel may be bent and shaped to create a ‘backbone’ including the front wall 106, base 108, and rear wall fixed portion 136. This and the other structural components of the spreader 100 such as the side walls 104 and frame 101 are preferably welded together to form a strong and durable. The rear access panel 138 and top 110 may include rubber seals (not shown) to create a generally weather-proof hopper 112. When removed from a vehicle, the spreader 100 may be stored on a support stand (not shown) in a garage or warehouse while the vehicle may be returned to other service.

The hopper 112 is designed to hold various particulate materials including, but not limited to, road salt (hereinafter solely used for the sake of brevity and not to limit the exemplary embodiment). The lid 110 may be manually removed via handles 156 as needed to fill the hopper 112 with road salt. The hopper 112 includes a series of apertures 140 formed in the downward sloped portion 126 of the baffle 116. The arrangement of the apertures 140 allow road salt to be gravity fed into the dispensing arrangement 114.

When an empty hopper 112 is first filled, an amount of the salt falls through the apertures 140 and into the dispensing arrangement 114 where it forms piles that extend upwardly back into the hopper 112. Once the apertures 140 are filled with road salt, the hopper 112 begins to be filled with road salt until a desired amount is reached. The road salt remains in the hopper 112 in a static condition while the agitator 118 is stopped.

When actuated by an operator, the agitator 118 begins to rotate. The road salt piled in the dispensing arrangement 114 beneath the apertures 140 and in contact with the agitator 118 is pushed towards the fixed rear wall portion 136 and begins to accumulate. As the agitator 118 continues to rotate and move road salt from beneath the apertures 140 in the baffle 116, road salt in the hopper 112 is gravity fed into the dispensing arrangement 114 to replace the displaced salt. As the agitator 118 continues to operate, more road salt accumulates against the fixed rear wall 136 and the level begins to rise. The road salt rises upwardly along the rear fixed wall portion 136 towards a series of dispensing apertures 142 located in the rear wall 106 of the spreader 100. Upon reaching the apertures 142, the salt is pushed out of the spreader 100 and pulled by gravity to the ground beneath. Road salt continues to be disbursed in this manner until the agitator 118 is stopped (or until the road salt runs out), at which time the remaining road salt returns to a static state and remains in the spreader 100. The road salt accumulated in the dispensing arrangement 114 against the fixed rear wall portion 136 remains at or below the level of the apertures 142 until the agitator 118 is actuated again or the spreader 100 is opened up and cleaned out.

The agitator 118 in the exemplary embodiment is illustrated as a beater bar having paddles 150 welded to a hollow shaft 152. The agitator 118 is driven by an actuator, such as a gear reduction motor 154, mounted on a side wall 104 on the outside of the spreader 100. The agitator 118 can be easily replaced with one having paddles 150 shaped, sized, or arranged differently to optimize the flow of different types of road salt. Nylon spacers 153 on the shaft 152 minimize the amount of force needed to turn the agitator 118 against the weight of a hopper 112 full of road salt. The torque required to rotate the agitator 118 is further minimized with the baffle 116 bearing a substantial amount of the weight of the road salt in the hopper 112. Sealed bearings (not shown) are also preferred to protect the shaft 152 and motor 154 from corrosion.

Simple operator controls may be provided such as ON/OFF switch and a variable rheostat to adjust rotational speeds to the agitator 118 may be provided. The controls allow an operator to adjust the amount of road salt delivered for a particular application. The motor 154 is preferably rated for washdown duty to minimize environmental and corrosive effects.

Handles 156 are provided on the lid 110, baffle 116, and rear access panel 138 to assist with their removal from or placement onto the spreader 100. The handles 156 on the lid 110 may be modified so as to hold a tool such as a shovel or scraper in place. Rubber tie-downs, bungee cords, or straps (not shown) may be provided to help secure the lid 110 to the spreader 100. Gaskets or foam strips may be included to prevent snow and excessive moisture from getting into the hopper 112. A small, manual dispensing container (i.e., a scoop) may be provided and stored within the hopper 112 via a mounting bracket for manual disbursement of road salt as needed.

The baffle 116 is generally planar and sufficiently thick to support the weight of the salt in the hopper 112. The apertures 140 in the baffle 116 are sized and located such that the piles of salt initially formed beneath each aperture 140 come into contact with the paddles 150 on the agitator 118. The size and placement of the apertures 140, as well as the angle of the downward sloped portion 126, may be modified to optimize the flow of road salt through the spreader 100.

The dispensing apertures 142 in the illustrated embodiment are depicted as being arranged in multiple groupings spaced apart from each other. Covers (not shown) may be provided such that one or more of the groupings of apertures 142 may be blocked to limit the area of road salt dispersed such as may be needed on a narrow walkway. The size or number of the dispensing apertures 142 may also be modified for a particular application.

When needed, the rear access panel 138 may be removed to access and clean the hopper 112 and the dispensing arrangement 114. The lid 110 and baffle 116 may also be removed to clean the hopper 112 and dispensing arrangement 114 from above. A drain 158 is provided in the base 108 to facilitate the cleanout and removal of salt from the spreader 100. The motor 154 and agitator 118 are easily removed to be repaired or replaced. Advantages of the spreader 100 include easy access to the interior, no mechanical gates, no auger, precise control, the use of a small actuator, and rugged construction.

A number of implementations have been described. Nevertheless, it will be understood that various modification may be made to the spreader yet remain within the scope of the following claims. For example, advantageous results may be achieved if the steps of the disclosed techniques were performed in a different sequence, or if components of the disclosed spreader were combined in a different manner, or if the components were supplemented with other components, or if the components were modified in shape or size.

What is claimed is:

1. A drop spreader for dispensing aggregate material onto a surface, the drop spreader comprising:
a mounting assembly for attaching the drop spreader to a vehicle;
a hopper for holding aggregate material;
a dispensing arrangement in communication with the hopper;
a barrier disposed between the hopper and the dispensing arrangement; the barrier configured to support the aggregate material within the hopper; and
a first opening for receiving the aggregate material into the hopper and a second opening for transferring the aggregate material from the hopper into a dispensing arrangement;
wherein the dispensing arrangement includes an agitator having a transversely extending shaft; wherein the spreader includes a third opening for discharging the aggregate material from the spreader; and wherein, when the agitator is actuated, the aggregate material is transferred from the hopper into the dispensing arrangement and towards the third discharge opening.

2. The drop spreader of claim 1, further comprising an actuator to drive the agitator.

3. The drop spreader of claim 2, wherein the actuator is an electric motor connected to a shaft of the agitator.

4. The drop spreader of claim 3, wherein the electric motor is a gear reduction motor rated for washdown duty.

5. The drop spreader of claim 3, wherein the electric motor is mounted on the outside of the spreader.

6. The drop spreader of claim 3, further comprising a variable speed controller for adjusting the rotational speed of the agitator.

7. The drop spreader of claim 1, wherein the transversely extending agitator shaft is generally cylindrical in shape; the agitator further including at least one paddle affixed to the shaft.

8. The drop spreader of claim 1, wherein the barrier is generally planar and the second opening is formed with at least one aperture.

9. The drop spreader of claim 8, wherein the barrier is formed as a baffle with the at least one aperture contained therein.

10. The drop spreader of claim 9, wherein the baffle is removable from the spreader.

11. The drop spreader of claim 1, wherein the hopper includes an inwardly extending wall.

12. The drop spreader of claim 1, wherein the hopper includes at least three vertically extending planar walls.

13. An aggregate material drop spreader device comprising:
a hopper including one inwardly sloping sidewall and three substantially vertical sidewalls;
an aggregate material feed opening formed in a bottom of the hopper;
an agitator positioned in close proximity to the feed opening, the agitator including at least one protrusion for moving aggregate material away from the hopper, the agitator positioned such that the at least one protrusion is in contact with aggregate material moving through the discharge opening; and
an actuator operatively connected to the agitator for driving the agitator.

14. The drop spreader of claim 13, wherein the actuator is an electric motor that is mounted to the agitator.

15. The drop spreader of claim 14, further including a controller operatively connected to the electric motor for adjusting the speed of the agitator.

16. The drop spreader of claim 14, wherein the electric motor is mounted to a sidewall outside of the hopper; the drop spreader further including a plurality of discharge openings for dispensing aggregate material to the ground beneath the spreader.

17. The drop spreader of claim 13, wherein the bottom of the hopper is a baffle with at least one aggregate material feed opening formed therein.

18. The drop spreader of claim 17, wherein the baffle is generally flat with a downwardly curved section containing the least one aggregate material feed opening.

19. The drop spreader of claim 17, wherein the baffle is removable.

20. A drop spreader comprising:
a hopper with an upwardly extending opening for holding aggregate material;
a transversely extending agitator mounted beneath the hopper;
a removable baffle separating the hopper and the agitator; the baffle configured to support a majority of the aggregate material within the hopper; the baffle having a plurality of apertures formed therein for directing aggregate material towards the agitator; and
at least one group of apertures for dispensing aggregate material from the spreader;
wherein aggregate material is moved from the hopper towards the at least one group of apertures when the agitator is actuated.
